(19) United States
(12) Patent Application Publication
(10) Pub. No.: US 2026/0151981 A1
(43) Pub. Date: Jun. 4, 2026

(54) DRY-FORMING MOULD SYSTEM AND METHOD FOR COLLECTING CELLULOSE PRODUCTS IN A DRY-FORMING MOULD SYSTEM

(71) Applicant: PULPAC AB, Västra Frölunda (SE)

(72) Inventor: Ove LARSSON, Västra Frölunda (SE)

(21) Appl. No.: 19/113,003

(22) PCT Filed: Aug. 28, 2023
(86) PCT No.: PCT/EP2023/073537

§ 371 Date: Mar. 19, 2025

(30) Foreign Application Priority Data
Sep. 19, 2022 (SE) 2251083-8

(51) Int. Cl. B31D 5/02; B31B 50/59; B31B 50/74; B31B 50/98; B31F 1/00

(52) U.S. Cl. CPC B31D 5/02; B31B 50/592; B31B 50/741; B31B 50/98; B31F 1/0077

(57) ABSTRACT

A dry-forming mould system comprising a forming mould for dry-forming cellulose products from an air-formed cellulose blank structure. The forming mould comprises a first mould part and a second mould part configured for interacting with 2024/061575 each other during dry-forming of the cellulose products from the air-formed cellulose blank structure in the forming mould. The dry-forming mould system comprises a transporting unit and a collecting unit, and the transporting unit is configured for transporting the dry-formed cellulose products from the forming mould to the collecting unit. The collecting unit comprises an elongated product flow channel configured for receiving and guiding the cellulose products, and the product flow channel is configured for receiving several consecutive cellulose products from the forming mould.

### TECHNICAL FIELD

The present disclosure relates to a dry-forming mould system comprising a forming mould for dry-forming cellulose products from an air-formed cellulose blank structure. The forming mould comprises a first mould part and a second mould part configured for interacting with each other during forming of the cellulose products from the air-formed cellulose blank structure in the forming mould. The dry-forming mould system comprises a transporting unit and a collecting unit. The disclosure further relates to a method for collecting cellulose products in a dry-forming mould system.

### BACKGROUND

Cellulose fibres are commonly used as raw material for producing or manufacturing products. Products formed of cellulose fibres can be used in many different situations where there is a need for sustainable products. A wide range of products can be produced from cellulose fibres and a few examples are disposable plates and cups, cutlery, lids, bottle caps, coffee pods, blank structures, and packaging materials.

Forming mould systems are commonly used when manufacturing cellulose products from raw materials including cellulose fibres, and traditionally the cellulose products have been produced by wet-forming methods. A material commonly used for wet-forming cellulose fibre products is wet moulded pulp. Wet-formed products are generally formed by immersing a suction forming mould into a liquid or semi liquid pulp suspension or slurry comprising cellulose fibres, and when suction is applied, a body of pulp is formed with the shape of the desired product by fibre deposition onto the forming mould. With all wet-forming methods, there is a need for drying of the wet moulded product, where the drying process is a time and energy consuming part of the production. The demands on aesthetical, chemical and mechanical properties of cellulose products are increasing, and due to the properties of wet-formed cellulose products, the mechanical strength, flexibility, freedom in material thickness, and chemical properties are limited. It is also difficult in wet-forming processes to control the mechanical properties of the products with high precision.

One development in the field of producing cellulose products is dry-forming of cellulose products without using wet-forming methods. Instead of forming the cellulose products from a liquid or semi liquid pulp suspension or slurry, an air-formed cellulose blank structure is used. The air-formed cellulose blank structure is inserted into a forming mould and during the dry-forming of the cellulose products, the cellulose blank is subjected to a high forming pressure and a high forming temperature. One difficulty with dry-forming methods is the problem with removing the dry-formed cellulose products from the forming mould and handling the removed cellulose products in an efficient way. The removal and handling of the cellulose products after the dry-forming operation is further a time consuming and complicated operation, and there is thus a need for a more efficient dry-forming mould system.

### SUMMARY

An object of the present disclosure is to provide a dry-forming mould system and a method for collecting cellulose products in a dry-forming mould system, where the previously mentioned problems are avoided. This object is at least partly achieved by the features of the independent claims. The dependent claims contain further developments of the dry-forming mould system and the method for collecting cellulose products in a dry-forming mould system.

The disclosure concerns a dry-forming mould system comprising a forming mould for dry-forming cellulose products from an air-formed cellulose blank structure. The forming mould comprises a first mould part and a second mould part configured for interacting with each other during dry-forming of the cellulose products from the air-formed cellulose blank structure in the forming mould. The dry-forming mould system comprises a transporting unit and a collecting unit, and the transporting unit is configured for transporting the dry-formed cellulose products from the forming mould to the collecting unit. The collecting unit comprises an elongated product flow channel configured for receiving and guiding the cellulose products, and the product flow channel is configured for receiving several consecutive cellulose products from the forming mould.

Advantages with these features are that the dry-formed cellulose products can be efficiently removed from the forming mould and handled after the dry-forming process in an efficient way. The removal and handling of the cellulose products after the dry-forming operation is simplified with the transporting unit and the collecting unit, and with these features, a more efficient dry-forming mould system is enabled. The transporting unit is efficiently transporting the dry-formed cellulose products from the forming mould to the collecting unit. The collecting unit comprises an elongated product flow channel configured for receiving and guiding the cellulose products, and the product flow channel is receiving several consecutive cellulose products from the forming mould for an efficient handling of the dry-formed cellulose products.

In one embodiment, the product flow channel comprises an inlet opening and an outlet opening, and the product flow channel has an extension between the inlet opening and the outlet opening. The product flow channel is configured for guiding the cellulose products from the inlet opening to the outlet opening. The extension of the product flow channel between the inlet opening and the outlet opening is enabling the guiding of several consecutive cellulose products for an efficient cellulose product handling operation after the dry-forming process. The length of the product flow channel can be designed for receiving a specific number of dry-formed cellulose products, and in this way, the cellulose products are collected within the product flow channel before further handling.

In one embodiment, the product flow channel has a cross-sectional shape corresponding to an outer peripheral shape of the cellulose products. The corresponding cross-sectional shape is securing an efficient guiding of the cellulose products in the product flow channel, and the risk for tilted products in the product flow channel is minimized.

In one embodiment, the dry-forming mould system further comprises a release unit configured for releasing the cellulose products into the product flow channel. The release unit is efficiently releasing the dry-formed cellulose products into the product flow channel after transportation from the forming mould by means of the transportation unit.

In one embodiment, the release unit pushes consecutive cellulose products into the product flow channel for stacking the cellulose products in the product flow channel. The release unit is enabling an efficient stacking process of consecutive cellulose products in the product flow channel through a pushing action. In this way, consecutive cellulose products are stacked in the product flow channel for an efficient product handling operation, where the stack of cellulose products can be further handled when removed from the product flow channel.

In one embodiment, the dry-forming mould system further comprises a cutting unit configured for at least partly cutting out the cellulose products from the cellulose blank structure into a desired shape in the forming mould or in connection to the forming mould. The cutting unit is used for separating the dry-formed cellulose products from the cellulose blank structure, and the cutting unit is through the cutting operation forming the outer product edge shape of the cellulose products.

In one embodiment, the cutting unit comprises a cutting edge having a shape corresponding to an outer product edge of the cellulose products.

In one embodiment, the cutting edge is configured for cutting out the cellulose products from a compacted section of the cellulose blank structure. By cutting out the cellulose products from a compacted section of the cellulose blank structure, a sharp outer product edge is efficiently formed. The compacted section is stabilizing the cellulose fibres during the cutting operation.

In one embodiment, the cutting edge comprises at least one compression section configured for compacting at least one corresponding connection portion of the cellulose blank structure to a predetermined compression level for partly connecting the cellulose products to a residual portion of the cellulose blank structure. The compression section may be arranged as a blunt or flat surface section of the cutting edge, and the compression section is not cutting the cellulose fibres but instead compacting them. The connection portion is in this way forming a bridging section with compressed cellulose fibres that is connecting the formed cellulose product and the residual part of the cellulose blank structure.

In one embodiment, the cutting edge comprises at least one indentation section with a predetermined depth relative to an outer edge of the cutting edge. The indentation section is configured for compacting at least one corresponding connection portion of the cellulose blank structure to a predetermined compression level for partly connecting the cellulose products to a residual portion of the cellulose blank structure. The indentation section is configured for compacting at least one corresponding connection portion of the cellulose blank structure to a predetermined compression level for partly connecting the cellulose products to a residual portion of the cellulose blank structure. The indentation section may be arranged as cut out part of the cutting edge, and the indentation section is not cutting the cellulose fibres but instead compacting them. The connection portion is in this way forming a bridging section with compressed cellulose fibres that is connecting the formed cellulose product and the residual part of the cellulose blank structure.

In one embodiment, the transporting unit is configured for transporting the residual portion with the connected cellulose products from the forming mould to the release unit. The transporting unit is in this way efficiently transporting the residual portion of the cellulose blank structure together with the dry-formed cellulose products, and the cellulose products are partly connected to the residual portion via the connection portion. The connection portion is facilitating the transportation operation from the forming mould.

In one embodiment, the release unit is configured for releasing the cellulose products from the residual portion into the product flow channel by parting the connection portion from the residual portion. The release unit may thus be used for separating the cellulose products from the residual portion of the cellulose blank structure.

In one embodiment, the release unit comprises a cutting device configured for parting the connection portion from the residual portion.

In one embodiment, the collecting unit comprises a curing device arranged in connection to the product flow channel. The curing device comprises a heating unit configured for heating the cellulose products in the product flow channel. The heating unit is configured to heat the cellulose products to a predetermined temperature that creates evaporation of water from the cellulose products and to cure additives in the cellulose products. The dry-formed cellulose product may contain certain amounts of water that is evaporated in the curing device, and if additives are contained in the dry-formed cellulose products, these are heat treated for an efficient curing process.

In one embodiment, the heating unit is configured for blowing a stream of hot air into the product flow channel. The stream of hot air is efficiently evaporating water and curing additives.

In one embodiment, the curing device comprises a dehumidifier, where the dehumidifier is configured for dehumidifying the stream of hot air blown into the product flow channel.

In one embodiment, the product flow channel comprises at least one escape opening configured for allowing evaporated water to escape from the product flow channel. The at least one escape opening is suitable arranged as one or more holes in the side wall of the product flow channel.

In one embodiment, the product flow channel is configured for guiding the cellulose products during a predetermined curing dwell time. The curing dwell time may be different for different types of additives, and the guiding time in the product flow channel may be set for an efficient curing process during the predetermined curing dwell time. The product flow channel is thus used for collecting the cellulose products, stacking the cellulose products, and securing evaporation of water as well as an efficient curing process during the predetermined curing dwell time.

In one embodiment, the dry-forming mould system further comprises a storing unit. The storing unit is configured for receiving a plurality of stacked cellulose products from the product flow channel. The storing unit may have any suitable configuration for temporary or long-term storage of the formed cellulose products, such as for example a cardboard box, a plastic bag, or other suitable container for storage purposes.

In one embodiment, the dry-forming mould system further comprises a cutting unit configured for partly cutting out the cellulose products from the cellulose blank structure into a desired shape in the forming mould or in connection to the forming mould, while leaving the cellulose products partly connected to a residual portion of the cellulose blank structure via one or a plurality of connection portions. Thereby, position control of the cellulose products after cutting is simplified.

In one embodiment, the release unit comprises a cutting device configured for parting the cellulose products from the residual portion of the cellulose blank structure. Thereby, the cutting unit may be omitted, because the cutting device may be used for fully separating the formed cellulose products from the cellulose blank structure.

The disclosure further concerns a method for collecting cellulose products in a dry-forming mould system comprising a forming mould for dry-forming the cellulose products from an air-formed cellulose blank structure. The forming mould comprises a first mould part and a second mould part configured for interacting with each other during dry-forming of the cellulose products from the air-formed cellulose blank structure in the forming mould. The dry-forming mould system comprises a transporting unit and a collecting unit having an elongated product flow channel. The method comprises the steps: transporting the dry-formed cellulose products by means of the transporting unit from the forming mould to the collecting unit; receiving several consecutive cellulose products from the forming mould in the product flow channel and guiding the cellulose products in the product flow channel.

Advantages with the method are that the dry-formed cellulose products can be efficiently removed from the forming mould and handled after the dry-forming process in an efficient way. The removal and handling of the cellulose products after the dry-forming operation is simplified with the transporting unit and the collecting unit, and with these steps, a more efficient dry-forming mould system is enabled. The transporting unit is efficiently transporting the dry-formed cellulose products from the forming mould to the collecting unit. The collecting unit comprises an elongated product flow channel configured for receiving and guiding the cellulose products, and the product flow channel is receiving several consecutive cellulose products from the forming mould for an efficient handling of the dry-formed cellulose products.

In one embodiment, the product flow channel comprises an inlet opening and an outlet opening, and the product flow channel has an extension between the inlet opening and the outlet opening. The method further comprises the step: guiding the cellulose products in the product flow channel from the inlet opening to the outlet opening. The extension of the product flow channel between the inlet opening and the outlet opening is enabling the guiding of several consecutive cellulose products for an efficient cellulose product handling operation after the dry-forming process. The length of the product flow channel can be designed for receiving a specific number of dry-formed cellulose products, and in this way, the cellulose products are collected within the product flow channel before further handling.

In one embodiment, the dry-forming mould system further comprises a release unit. The method further comprises the steps: releasing the cellulose products into the product flow channel; pushing consecutive cellulose products by the release unit into the product flow channel for stacking the cellulose products in the product flow channel. The release unit is efficiently releasing the dry-formed cellulose products into the product flow channel after transportation from the forming mould by means of the transportation unit. The release unit is enabling an efficient stacking process of consecutive cellulose products in the product flow channel.

In one embodiment, the dry-forming mould system further comprises a cutting unit having a cutting edge. The method further comprises the step: at least partly cutting out the cellulose products with the cutting edge from the cellulose blank structure in the forming mould or in connection to the forming mould. The cutting unit is used for separating the dry-formed cellulose products from the cellulose blank structure, and the cutting unit is through the cutting operation forming the outer product edge shape of the cellulose products.

In one embodiment, the method further comprises the step: cutting out the cellulose products with the cutting edge from a compacted section of the cellulose blank structure. By cutting out the cellulose products from a compacted section of the cellulose blank structure, a sharp outer product edge is efficiently formed. The compacted section is stabilizing the cellulose fibres during the cutting operation.

In one embodiment, the cutting edge comprises at least one compression section. The method further comprises the step: compacting at least one corresponding connection portion of the cellulose blank structure to a predetermined compression level with the at least one compression section for partly connecting the cellulose products to a residual portion of the cellulose blank structure. The compression section may be arranged as a blunt or flat surface section of the cutting edge, and the compression section is not cutting the cellulose fibres but instead compacting them. The connection portion is in this way forming a bridging section with compressed cellulose fibres that is connecting the formed cellulose product and the residual part of the cellulose blank structure.

In one embodiment, the cutting edge comprises at least one indentation section with a predetermined depth relative to an outer edge of the cutting edge. The method further comprises the step: compacting at least one corresponding connection portion of the cellulose blank structure to a predetermined compression level with the indentation section for partly connecting the cellulose products to a residual portion of the cellulose blank structure. The indentation section is configured for compacting at least one corresponding connection portion of the cellulose blank structure to a predetermined compression level for partly connecting the cellulose products to a residual portion of the cellulose blank structure. The indentation section may be arranged as cut out part of the cutting edge, and the indentation section is not cutting the cellulose fibres but instead compacting them. The connection portion is in this way forming a bridging section with compressed cellulose fibres that is connecting the formed cellulose product and the residual part of the cellulose blank structure.

In one embodiment, the method further comprises the step: transporting the residual portion with the connected cellulose products by means of the transporting unit from the forming mould to the release unit. The transporting unit is in this way efficiently transporting the residual portion of the cellulose blank structure together with the dry-formed cellulose products, and the cellulose products are partly connected to the residual portion via the connection portion. The connection portion is facilitating the transportation operation from the forming mould.

In one embodiment, the method further comprises the step: releasing the cellulose products by means of the release unit from the residual portion into the product flow channel by parting the connection portion from the residual portion. The release unit may thus be used for separating the cellulose products from the residual portion of the cellulose blank structure.

In one embodiment, the collecting unit comprises a curing device arranged in connection to the product flow channel, where the curing device comprises a heating unit. The method further comprises the step: heating the cellulose products by means of the heating unit in the product flow channel to a predetermined temperature creating evaporation of water from the cellulose products and curing of additives in the cellulose products. The dry-formed cellulose product may contain certain amounts of water that is evaporated in the curing device, and if additives are contained in the dry-formed cellulose products, these are heat treated for an efficient curing process. In one embodiment, the method further comprises the step: blowing a stream of hot air by means of the heating unit into the product flow channel. The stream of hot air is efficiently evaporating water and curing additives.

In one embodiment, the curing device comprises a dehumidifier. The method further comprises the step: dehumidifying the stream of hot air blown into the product flow channel by means of the dehumidifier.

In one embodiment, the method further comprises the step: guiding the cellulose products in the product flow channel during a predetermined curing dwell time. The curing dwell time may be different for different types of additives, and the guiding time in the product flow channel may be set for an efficient curing process during the predetermined curing dwell time. The product flow channel is thus used for collecting the cellulose products, stacking the cellulose products, and securing evaporation of water as well as an efficient curing process during the predetermined curing dwell time.

In one embodiment, the dry-forming mould system further comprises a storing unit. The method further comprises the step: receiving a plurality of stacked cellulose products from the product flow channel in the storing unit. The storing unit may have any suitable configuration for temporary or long-term storage of the formed cellulose products, such as for example a cardboard box, a plastic bag, or other suitable container for storage purposes.

### BRIEF DESCRIPTION OF DRAWINGS

The disclosure will be described in detail in the following, with reference to the attached drawings, in which

FIG. 1a-e show schematically, in side views, a dry-forming mould system in different operational steps, according to an embodiment,

FIG. 2 shows schematically, in a side view, a collecting unit and a release unit of the dry-forming mould system, according to an embodiment,

FIG. 3a-d show schematically, in side views and in a view from below, a forming mould with a cutting unit of the dry-forming mould system, according to an embodiment,

FIG. 4a-b show schematically, in views from above, a cellulose blank structure with a formed cellulose product cut out from the cellulose blank structure, according to different embodiments,

FIG. 5a-c show schematically, in a side view and in perspective views, a cutting edge of the cutting unit comprising a compression section for compacting a corresponding connection portion of the cellulose blank structure, according to an embodiment,

FIG. 6a-b show schematically, in a side view and in a perspective view, a cutting edge of the cutting unit comprising an indentation section for compacting a corresponding connection portion of the cellulose blank structure, according to an embodiment,

FIG. 7 shows schematically, in a view from above, a cellulose blank structure with a formed cellulose product cut out from the cellulose blank structure, where the connection portion is partly connecting the cellulose product to a residual portion of the cellulose blank structure, according an embodiment, and

FIG. 8a-b show schematically, in a side view, a dry-forming mould system in a multi-cavity configuration, and in a view from above, a cellulose blank structure with formed cellulose products cut out from the cellulose blank structure, according to an alternative embodiment.

### DESCRIPTION OF EXAMPLE EMBODIMENTS

Various aspects of the disclosure will hereinafter be described in conjunction with the appended drawings to illustrate and not to limit the disclosure, wherein like designations denote like elements, and variations of the described aspects are not restricted to the specifically shown embodiments, but are applicable on other variations of the disclosure.

The disclosure concerns a dry-forming mould system S, where the dry-forming mould system S comprises one or more forming moulds 3 for dry-forming cellulose products 1 from an air-formed cellulose blank structure 2. Each forming mould 3 comprises a first mould part 3a and a second mould part 3b configured for interacting with each other during dry-forming of the cellulose products 1 from the air-formed cellulose blank structure 2.

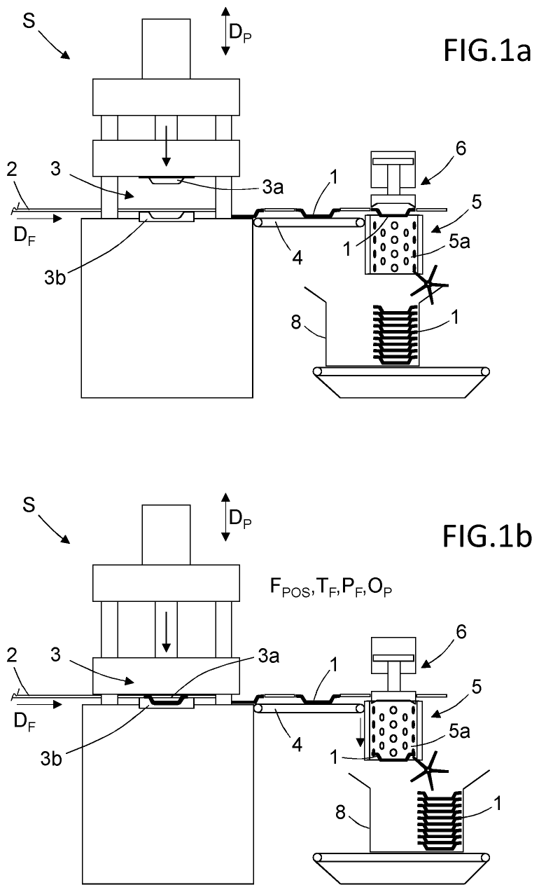

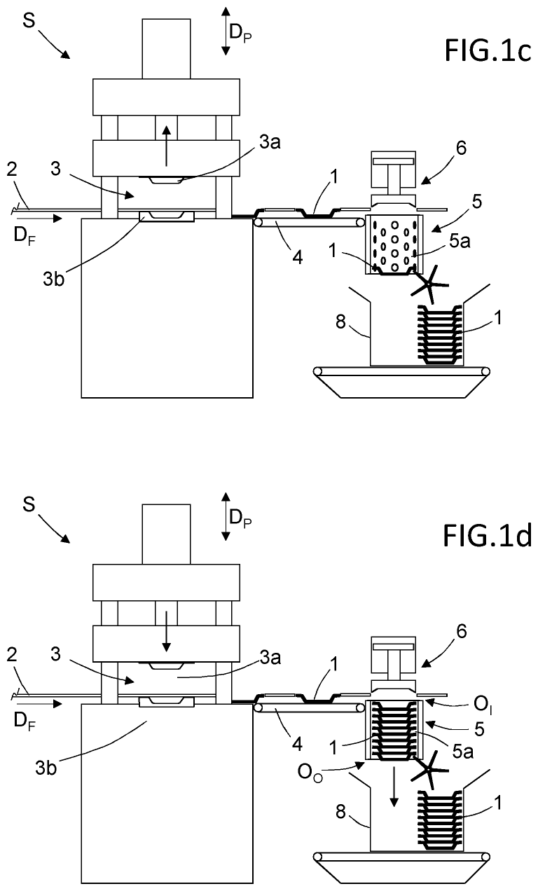

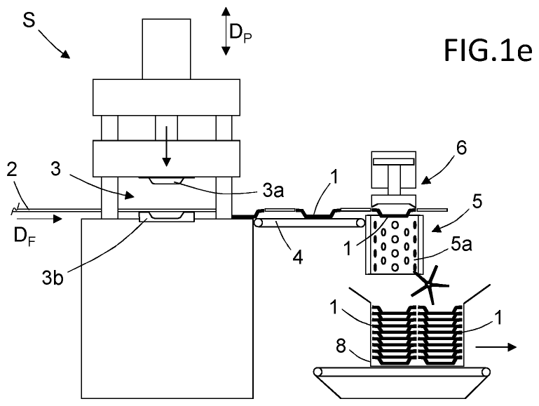

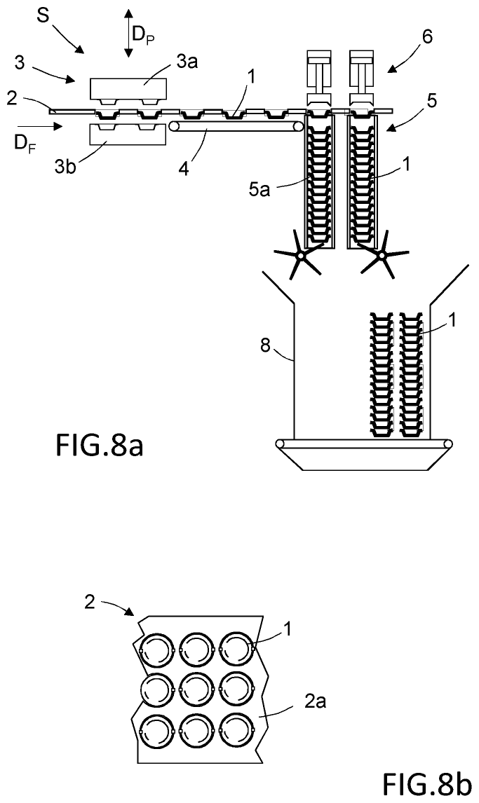

The dry-forming mould system S may be of a single-cavity configuration or alternatively of a multi-cavity configuration. A single-cavity mould system comprises only one forming mould 3 with first and second mould parts, as shown in the embodiment illustrated in FIGS. 1 a-e. A multi-cavity mould system comprises two or more forming moulds 3, each having cooperating first and second mould parts. In the embodiment illustrated in FIGS. 8a-b, the dry-forming mould system S is arranged as a multi-cavity mould system comprising a plurality of forming moulds 3 with first and second mould parts, where the movements of the mould parts suitably are synchronized for a simultaneous forming operation.

With an air-formed cellulose blank structure 2 is meant an essentially air-formed fibrous web structure produced from cellulose fibres. The cellulose fibres may originate from a suitable cellulose raw material, such as a pulp material. Suitable pulp materials are for example fluff pulp, paper structures, or other cellulose fibre-containing structures. With air-forming of the cellulose blank structure 2 is meant the formation of a cellulose blank structure in a dry-forming process in which the cellulose fibres are air-formed to produce the cellulose blank structure 2. When air-forming the cellulose blank structure 2 in the air-forming process, the cellulose fibres are carried and formed to the fibre blank structure 2 by air as carrying medium. This is different from a normal papermaking process or a traditional wet-forming process, where water is used as carrying medium for the cellulose fibres when forming the paper or fibre structure. In the air-forming process, small amounts of water or other substances may if desired be added to the cellulose fibres in order to change the properties of the cellulose product, but air is still used as carrying medium in the forming process. The cellulose blank structure 2 may, if suitable have a dryness that is mainly corresponding to the ambient humidity in the atmosphere surrounding the air-formed cellulose blank structure 2. As an alternative, the dryness of the cellulose blank structure 2 can be controlled in order to have a suitable dryness level when forming the cellulose products 1.

The cellulose blank structure 2 may have a composition where the fibres are of the same origin or alternatively contain a mix of two or more types of cellulose fibres, depending on the desired properties of the cellulose products 1. The cellulose fibres used in the cellulose blank structure 2 are during the forming process of the cellulose products 1 strongly bonded to each other with hydrogen bonds. The cellulose fibres may be mixed with other substances or compounds to a certain amount as will be further described below. With cellulose fibres is meant any type of cellulose fibres, such as natural cellulose fibres or manufactured cellulose fibres. The cellulose blank structure 2 may specifically comprise at least 95% cellulose fibres, or more specifically at least 99% cellulose fibres. However, the cellulose blank structure 2 may have other suitable configurations and cellulose fibre amounts.

The air-formed cellulose blank structure 2 may have a single-layer or a multi-layer configuration. A cellulose blank structure 2 having a single-layer configuration is referring to a structure that is formed of one layer containing cellulose fibres. A cellulose blank structure 2 having a multi-layer configuration is referring to a structure that is formed of two or more layers comprising cellulose fibres, where the layers may have the same or different compositions or configurations.

One or more reinforcement layers comprising cellulose fibres may be added to the cellulose blank structure 2. The one or more reinforcement layers may be arranged as carrying layers for the cellulose blank structure 2. The reinforcement layer may have a higher tensile strength than the cellulose blank structure 2. This is useful when one or more air-formed layers of the cellulose blank structure 2 have compositions with low tensile strength in order to avoid that the cellulose blank structure 2 will break during the forming of the cellulose products 1. The reinforcement layer with a higher tensile strength acts in this way as a supporting structure for the cellulose blank structure 2. The reinforcement layer may be of a different composition than the cellulose blank structure 2, such as for example a tissue layer containing cellulose fibres, an airlaid structure comprising cellulose fibres, or other suitable layer structures. It is thus not necessary that the reinforcement layer is air-formed.

The cellulose blank structure 2 may further comprise or be arranged in connection to one or more barrier layers giving the cellulose products the ability to hold or withstand liquids, such as for example when the cellulose products 1 are used in contact with beverages, food, and other water-containing substances. The one or more barrier layers may be of a different composition than the rest of the cellulose blank structure 2, such as for example a tissue barrier structure.

The one or more air-formed layers of the cellulose blank structure 2 are fluffy and airy structures, where the cellulose fibres forming the structures are arranged relatively loosely in relation to each other. The fluffy cellulose blank structures 2 are used for an efficient forming of the cellulose products 1, allowing the cellulose fibres to form the cellulose products 1 in an efficient way during the forming process.

In the embodiments illustrated in FIGS. 1a-e and 8a, the one or more second mould parts 3b are stationary and the one or more first mould parts 3a are movably arranged relative to the second mould parts 3b in the pressing direction D_{P}, during the pressing operation O_{P}. The one or more first mould parts 3a are configured to move both towards the corresponding second mould parts 3b and away from the second mould parts 3b in linear movements along an axis extending in the pressing direction D_{P}.

In alternative embodiments, during the pressing operation O_{P}, the one or more first mould parts 3a may be stationary with the corresponding one or more second mould parts 3b movably arranged in relation to the first mould parts 3a, or both the one or more first mould parts 3a and the corresponding one or more second mould parts 3b may be movably arranged in relation to each other.

It should be understood that for all embodiments according to the disclosure, the expression moving in the pressing direction D_{P}, includes a movement in the pressing direction D_{P}, and the movement may take place in opposite directions. The expression may further include both linear and non-linear movements of a mould part, where the result of the movement during forming is a repositioning of the mould part in the pressing direction D_{P}.

With the expression pressing operation O_{P} is meant the operation of the mould parts for forming a cellulose product from the cellulose blank structure. The pressing operation O_{P} starts when the one or more first mould parts 3a and/or the one or more second mould parts 3b are moved from a stationary position. In this position, the one or more first mould parts 3a and the one or more second mould parts 3b are arranged at a distance from each other and the cellulose blank structure 2 can be fed into the forming mould 3 in a forming position between the one or more first mould parts 3a and the one or more second mould parts 3b. Thereafter, the one or more first mould parts 3a and/or the one or more second mould parts 3b are moved towards each other for applying a forming pressure onto the cellulose blank structure 2 and then moved away from each other back to the stationary position. When the mould parts have reached the stationary position again, the pressing operation O_{P} is completed. The pressing operation O_{P} is thus defined as a pressing cycle during which the cellulose blank structure is exerted to a forming pressure, and the duration of the pressing operation O_{P} is calculated from the start of the movements of the one or more first mould parts 3a and/or the one or more second mould parts 3b from the stationary position until they have reached the stationary position again.

It should be understood that a forming pressure may be applied to the cellulose blank structure 2 in only one pressing step during the pressing operation O_{P}. Alternatively, a forming pressure may be applied in two or more repeated pressing steps during the pressing operation O_{P}, and in this way the mould parts are repeatedly exerting a forming pressure onto the cellulose blank structure.

Suitably, the pressing operation O_{P} is a single pressing operation, in which a forming pressure is applied to the cellulose blank structure 2 in only one pressing step during the pressing operation O_{P}. With the single pressing operation is thus meant that the cellulose product 1 is formed from the cellulose blank structure 2 in one single pressing step in the dry-forming mould system S. In the single pressing operation, the one or more first mould parts 3a and the one or more second mould parts 3b are interacting with each other for establishing a forming pressure and the forming temperature during a single operational engagement step. In the single pressing operation, a forming pressure and a forming temperature are not applied to the cellulose blank structure 2 in two or more repeated or subsequent pressing steps.

The cellulose products 1 are formed from the cellulose blank structure 2 in the one or more forming moulds 3 by heating the cellulose blank structure 2 to a forming temperature T_{F}, and pressing the cellulose blank structure 2 with a forming pressure P_{F} in the pressing operation O_{P}. The forming temperature T_{F} is in the range of 100-300° C., preferably in the range of 100-200° C., and the forming pressure P_{F} is in the range of 1-100 MPa, preferably in the range of 4-20 MPa. The first mould parts 3a are arranged for forming the cellulose products 1 through interaction with the corresponding second mould parts 3b. During forming of the cellulose products 1, the cellulose blank structure 2 is in each forming mould 3 exerted to the forming pressure P_{F} in the range of 1-100 MPa, preferably in the range of 4-20 MPa, and the forming temperature T_{F} in the range of 100-300° C., preferably in the range of 100-200° C. The cellulose products 1 are thus formed from the cellulose blank structure 2 between each of the first mould parts 3a and corresponding second mould parts 3b by heating the cellulose blank structure 2 to the forming temperature T_{F} in the range of 100-300° C., preferably in the range of 100-200° C., and by pressing the cellulose blank structure 2 with the forming pressure P_{F} in the range of 1-100 MPa, preferably in the range of 4-20 MPa. When forming the cellulose products 1, strong hydrogen bonds are formed between the cellulose fibres in the cellulose blank structure 2 arranged between the first mould parts 3a and the second mould parts 3b. The temperature and pressure levels are for example measured in the cellulose blank structure 2 during the forming process with suitable sensors arranged in or in connection to the cellulose fibres in the cellulose blank structure 2.

The dry-forming mould system S may further comprises a heating unit. The heating unit is configured for applying the forming temperature T_{F} onto the cellulose blank structure 2 in each forming mould 3. The heating unit may have any suitable configuration. The heating unit may be integrated in or cast into the first mould parts 3a and/or the second mould parts 3b, and suitable heating devices are e.g. electrical heaters, such as a resistor element, or fluid heaters. Other suitable heat sources may also be used.

FIGS. 1a-e schematically show an embodiment of a dry-forming mould system S having a single-cavity configuration. The dry-forming mould system S comprises a forming mould 3 for dry-forming cellulose products 1 from an air-formed cellulose blank structure 2. The forming mould 3 comprises a first mould part 3a and a second mould part 3b configured for interacting with each other during dry-forming of the cellulose products 1 from the air-formed cellulose blank structure 2 in the forming mould 3.

The first mould part 3a and the second mould part 3b are cooperating with each other in a pressing operation O_{P} during the forming of the cellulose products 1 in the dry-forming mould system S. The first mould part 3a and the corresponding second mould part 3b are movably arranged relative to each other, and the first mould part 3a and the second mould part 3b are configured for moving relative to each other in the pressing direction D_{P}.

As shown in FIGS. 1 a-e, the dry-forming mould system S further comprises a transporting unit 4 and a collecting unit 5. The transporting unit 4 is transporting the dry-formed cellulose products 1 from the forming mould 3 to the collecting unit 5. In the illustrated embodiment, the transporting unit 4 is arranged as an endless belt structure for transporting the dry-formed cellulose products 1 from the forming mould 3 to the collecting unit 5. However, the transporting unit 4 may have other suitable configurations, such as moving arm structures or industrial robots.

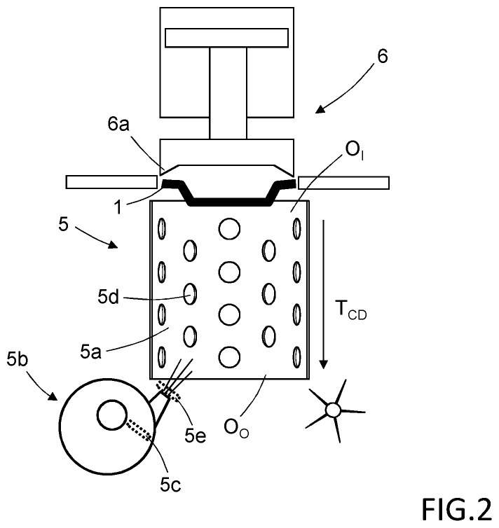

The collecting unit 5 comprises an elongated product flow channel 5a for receiving and guiding the cellulose products 1, as illustrated in FIGS. 1a-e and 2. The product flow channel 5a is arranged and designed for receiving several consecutive cellulose products 1 from the forming mould 3. The product flow channel 5a comprises an inlet opening O_{I} and an outlet opening O_{O}, as shown in FIG. 2, and the product flow channel 5a has an extension between the inlet opening O_{I} and the outlet opening O_{O}. The product flow channel 5a is configured for guiding the cellulose products 1 from the inlet opening O_{I} to the outlet opening O_{O}, as indicated with the arrow in FIG. 2. Suitably, the product flow channel 5a has a cross-sectional shape corresponding to an outer peripheral shape of the cellulose products 1.

The collecting unit 5 may further comprise a curing device 5b arranged in connection to the product flow channel 5a, as shown in FIG. 2. The curing device 5b comprises a heating unit 5c for heating the cellulose products 1 in the product flow channel 5a. The heating unit 5c is heating the cellulose products 1 to a predetermined temperature that creates evaporation of water from the cellulose products 1. The product flow channel 5a suitably comprises at least one escape opening 5d for allowing evaporated water to escape from the product flow channel 5a. The heating unit is also curing additives in the cellulose products 1. The product flow channel 5a is suitably guiding the cellulose products 1 during a predetermined curing dwell time T_{CD}. In the shown embodiment, the heating unit 5c is arranged as a fan with a heating element for blowing a stream of hot air into the product flow channel 5a. It should however be understood that the heating unit 5c may have other suitable configurations for heating the cellulose products 1 in the product flow channel 5a, such as heating elements arranged within the product flow channel 5a. The curing device 5b may further comprise a dehumidifier 5e. The dehumidifier 5e is used for dehumidifying the stream of hot air blown into the product flow channel 5a by the heating unit. The dehumidifier 5e may have any suitable configuration and in the illustrated embodiment, the dehumidifier 5e is arranged in connection to the curing device 5b. The stream of hot air produced by the heating unit 5c may, when leaving the product flow channel 5a, be used by other parts of the dry-forming mould system S for heating purposes, such as in the forming mould 3. The humidity in the stream of hot air leaving the product flow channel 5a may be directed to the cellulose blank structure 2 in the forming mould 3 or to the cellulose blank structure 2 before the forming mould 3 for controlling the humidity of the cellulose blank structure 2 when forming the cellulose products 1.

In other non-illustrated embodiments, the heat generated in the forming mould 3 may be directed to the product flow channel 5a for heating the cellulose products 1 in the product flow channel 5a.

The dry-forming mould system S further comprises a release unit 6, as shown in FIGS. 1a-e and 2. The release unit 6 is arranged for releasing the cellulose products 1 into the product flow channel 5a of the collecting unit 5. The release unit 6 pushes consecutive cellulose products 1 into the product flow channel 5a for stacking the cellulose products 1 in the product flow channel 5a.

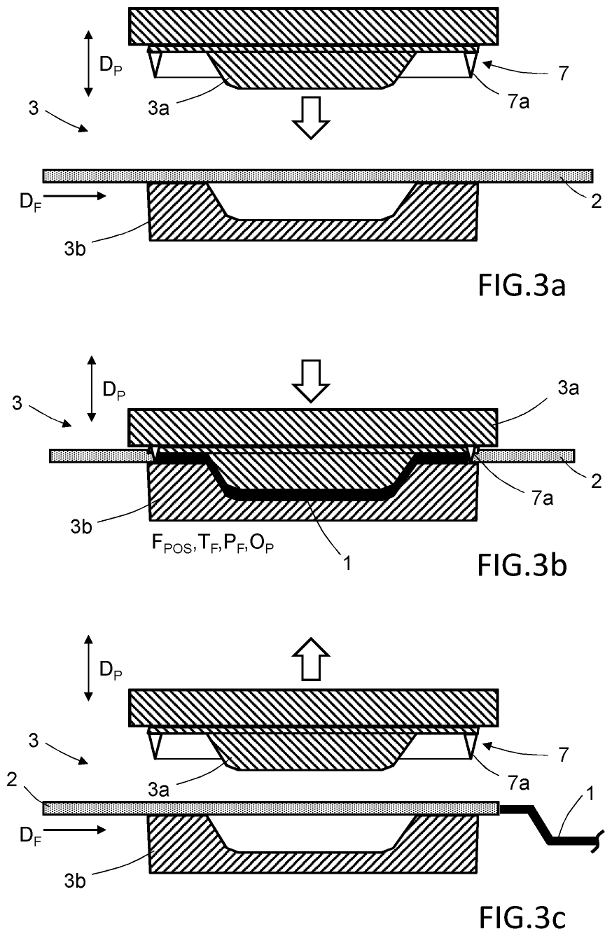

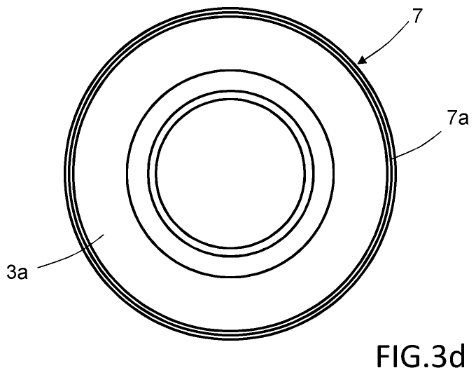

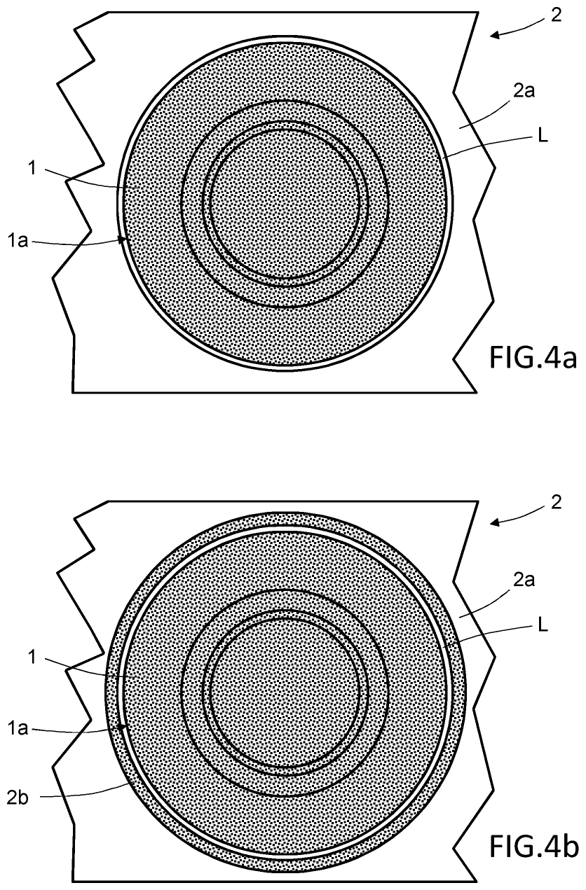

The dry-forming mould system S may further comprises a cutting unit 7. The cutting unit 7 is arranged for, at least partly, cutting out the cellulose products 1 from the cellulose blank structure 2 into a desired shape in the forming mould 3 or in connection to the forming mould 3. One embodiment of the cutting unit 7 is schematically illustrated in FIGS. 3a-d, where the cutting unit 7 is arranged as an integrated part of the forming mould 3. In this embodiment, the cutting unit 7 comprises a continuous cutting edge 7a arranged at an outer peripheral edge of the first mould part 3a. The cutting edge 7a suitably has a shape corresponding to an outer product edge 1a of the cellulose products 1 to be formed in the forming mould 3. In the embodiment shown in FIG. 3d, the cutting edge 7a is illustrated with a circular shape for cutting out formed cellulose products 1 with a circular outer product edge 1a from a residual part 2a of the cellulose blank structure 2, as illustrated with a cutting line L in FIGS. 4 a-b. In FIG. 4 a, the cutting line L is arranged in connection to a transition between a non-compacted residual part 2a of the cellulose blank structure 2 and the part of the cellulose blank structure 2 compacted in the forming mould 3 to form the cellulose product 1. In an alternative embodiment shown in FIG. 4b, the cutting edge 7a is cutting out the cellulose products 1 from a compacted section 2b of the cellulose blank structure 2. The compacted section 2b is suitable formed in the forming mould 3 together with the forming of the cellulose product 1. In FIG. 4b, the residual part 2a comprises the compacted section 2b after the cutting operation. The residual part 2a of the cellulose product may be recycled and used again for forming cellulose products 1.

The cutting edge 7a may have any suitable shape and configuration depending on the shape of the formed cellulose products 1. It should be understood that in other non-illustrated embodiments, the cutting unit 7 could be arranged separately from the forming mould 3.

When dry-forming the cellulose products 1, the cellulose blank structure 2 is fed in a feeding direction D_{F} between the first mould part 3a and the second mould part 3b when the forming mould 3 is in an open state, as shown in FIGS. 1a and 3a. When the cellulose blank structure 2 has been arranged in the forming mould 3, the first mould part 3a is moved towards the second mould part 3b during the dry-forming process. When the forming pressure P_{F} together with a suitable forming temperature T_{F} are established in the forming mould 3 onto the cellulose blank structure 2, the movement of the first mould part 3a is stopped in a product forming position F_{POS}, as shown in FIGS. 1b and 3b. In the forming position F_{POS}, the formed cellulose product may be cut out from the cellulose blank structure 2 by the cutting edge 7a, as shown in FIG. 3b. As shown in FIGS. 1c and 3c, the first mould part 3a is thereafter moved in a direction away from the second mould part 3b after a certain time duration or directly after the first mould part 3a has been stopped, and a new section of the cellulose blank structure 2 can be fed in the feeding direction D_{F} into the forming mould 3 between the first mould part 3a and the second mould part 3b. A suitable control system may be used for controlling the operation of the dry-forming mould system S and the forming mould 3.

The dry-forming mould system S further comprises a storing unit 8, as shown in FIGS. 1a-e. The storing unit 8 is receiving a plurality of stacked cellulose products 1 from the product flow channel 5a. The storing unit 8 may have any suitable configuration for temporary or long-term storage of the formed cellulose products 1, such as for example a cardboard box, a plastic bag, or other suitable container for storage purposes. In FIG. 1a, one stack of cellulose products 1 has been received by the storage unit 8. Further, in FIG. 1a, one formed cellulose products 1 has been transported by means of the transporting unit 4 from the forming mould 3 to the collecting unit 5 into a position where the cellulose product 1 can be released into the product flow channel 5a. In FIGS. 1b-c, the formed cellulose product 1 has been pushed by the release unit 6 into the product flow channel 5a, as indicated with the arrow in FIG. 1b. In this embodiment, the release unit 6 is arranged as a pushing mechanism that is pushing consecutive cellulose products 1 into the product flow channel 5a by a pushing action.

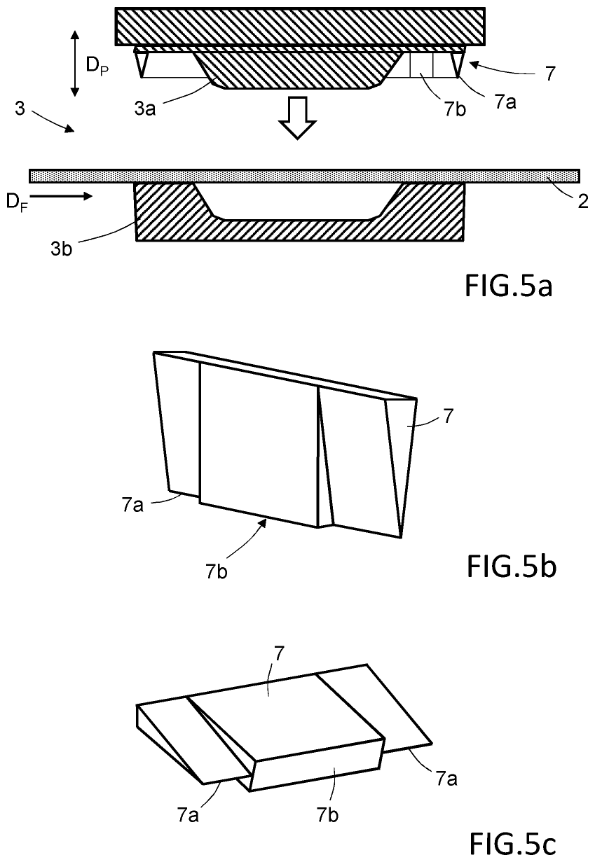

In the position shown in FIG. 1a, the formed cellulose product 1 has been transported into a position between the release unit 6 and the collecting unit 5. In FIG. 1b, the release unit 6 is pushing the cellulose product 1 into the product flow channel 5a, and in FIG. 5c, the release unit 6 has returned to a position where a consecutive cellulose product 1 can be transported by means of the transporting unit 4 to the collecting unit 5. The release unit 6 is thus pushing consecutive cellulose products 1 into the product flow channel 5a for stacking the cellulose products 1 in the product flow channel 5a, as understood from FIG. 1d. In this way, several consecutive cellulose products 1 from the forming mould 3 are received in the product flow channel 5a, and the cellulose products 1 are guided in the product flow channel 5a, from the inlet opening O_{I} to the outlet opening O_{O}. The cellulose products may be cured as described above in connection to FIG. 2, where the cellulose products 1 are guided in the product flow channel 5a during a predetermined curing dwell time T_{CD}. Once the product flow channel 5a is filled with cellulose products, as shown in FIG. 1d, the stacked cellulose products 1 can be released from the product flow channel 5a into the storing unit 8 as indicated with the arrow. In FIG. 1e, a plurality of stacked cellulose products 1 has been received in the storing unit 8. Once the storing unit 8 is filled with cellulose products, it may be transported away from the dry-forming mould system S, as indicated with the arrow in FIG. 1e, and a new storage unit 8 may be arranged to receive further formed cellulose products 1.

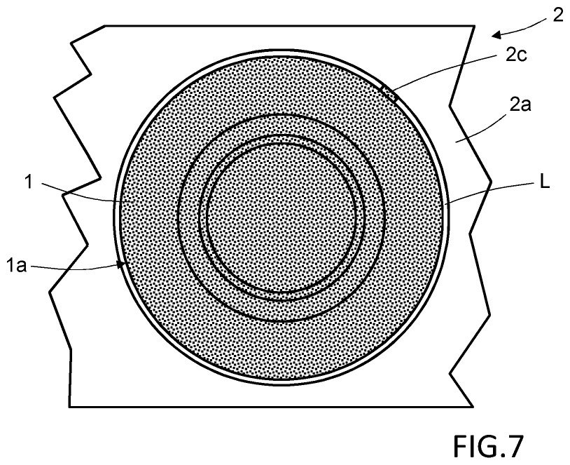

In alternative embodiments, the cutting unit 7 may be arranged with a cutting edge 7a, where the cutting edge 7a is only partly cutting out the cellulose products 1 from the cellulose blank structure 2 in the forming mould 3 or in connection to the forming mould 3. In this way, one or more connection portions 2c may be formed between the residual part 2a of the cellulose blank structure 2 and the formed cellulose product 1 after the cutting operation, as shown in FIG. 7.

In one embodiment, as illustrated in FIGS. 5a-c, the cutting edge 7a comprises at least one compression section 7b configured for compacting at least one corresponding connection portion 2c of the cellulose blank structure 2 to a predetermined compression level for partly connecting the cellulose products 1 to a residual portion 2a of the cellulose blank structure 2, as shown in FIG. 7. The compression section 7b may be arranged as a blunt or flat surface section of the cutting edge 7a, as understood from the figures, and the compression section 7b is not cutting the cellulose fibres but instead compacting them. The connection portion 2c is in this way forming a bridging section with compressed cellulose fibres that is connecting the formed cellulose product 1 and the residual part 2a of the cellulose blank structure 2. The connection portion 2c is simplifying transport of the cellulose blank structure 2 with the partly cut out cellulose product 1 from the forming mould 3 to the collecting unit 5 by means of the transportation unit 4. The transporting unit 4 is in this embodiment transporting the residual portion 2a with the connected cellulose products 1 from the forming mould 3 to the release unit 6. The release unit 6 is releasing the cellulose products 1 from the residual portion 2a into the product flow channel 5a by parting the connection portion 2c from the residual portion 2a. The release unit 6 suitably comprises a cutting device 6a configured for parting the connection portion 2c from the residual portion 2a, as indicated in FIG. 2.

In other non-illustrated embodiments, the cutting device 6a of the release unit 6 may be used for fully separating the formed cellulose products 1 from the cellulose blank structure 2. With such a design of the dry-forming mould system S, the cutting unit 7 may be omitted.

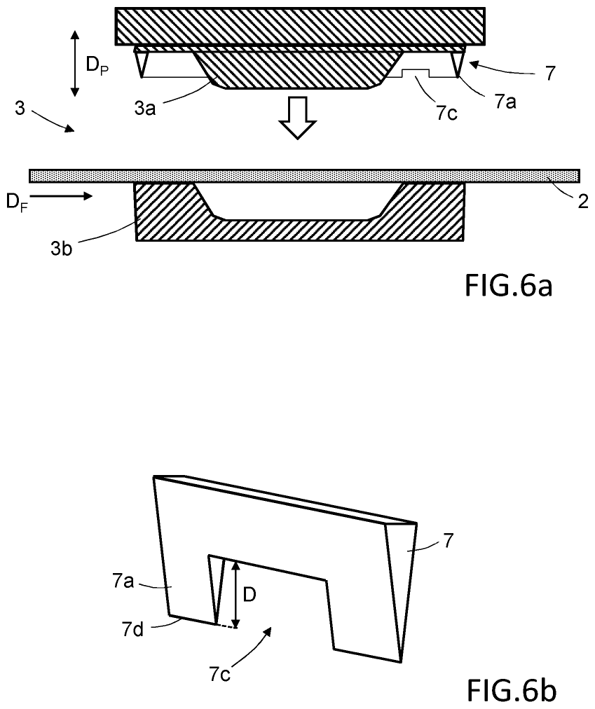

In one embodiment, as illustrated in FIGS. 6a-b, the cutting edge 7a comprises at least one indentation section 7c with a predetermined depth D relative to an outer edge 7d of the cutting edge 7a. The indentation section 7c is configured for compacting at least one corresponding connection portion 2c of the cellulose blank structure 2 to a predetermined compression level for partly connecting the cellulose products 1 to a residual portion 2a of the cellulose blank structure 2, as shown in FIG. 7. The indentation section 7b may be arranged as cut out part of the cutting edge 7a, as understood from the figures, and the indentation section 7b is not cutting the cellulose fibres but instead compacting them. The connection portion 2c is in this way forming a bridging section with compressed cellulose fibres that is connecting the formed cellulose product 1 and the residual part 2a of the cellulose blank structure 2. The connection portion 2c is simplifying transport of the cellulose blank structure 2 with the partly cut out cellulose product 1 from the forming mould 3 to the collecting unit 5 by means of the transportation unit 4. The transporting unit 4 is in this embodiment transporting the residual portion 2a with the connected cellulose products 1 from the forming mould 3 to the release unit 6. The release unit 6 is releasing the cellulose products 1 from the residual portion 2a into the product flow channel 5a by parting the connection portion 2c from the residual portion 2a. The release unit 6 suitably comprises a cutting device 6a, as indicated in FIG. 2, configured for parting the connection portion 2c from the residual portion 2a.

FIG. 8 a schematically shows an embodiment of a dry-forming mould system S having a multi-cavity configuration. The dry-forming mould system S comprises a plurality of forming moulds 3 for dry-forming cellulose products 1 from an air-formed cellulose blank structure 2. Each forming mould 3 comprises a first mould part 3a and a second mould part 3b configured for interacting with each other during dry-forming of the cellulose products 1 from the air-formed cellulose blank structure 2. The forming moulds may have the same configuration as described in the embodiments above.

As shown in FIG. 8 a, the dry-forming mould system S further comprises a transporting unit 4 and a collecting unit 5. The transporting unit 4 is transporting the dry-formed cellulose products 1 from the forming moulds 3 to the collecting unit 5. In the illustrated embodiment, the transporting unit 4 is arranged as an endless belt structure for transporting the dry-formed cellulose products 1 from the forming mould 3 to the collecting unit 5. However, the transporting unit 4 may have other suitable configurations, such as moving arm structures or industrial robots. FIG. 8b schematically illustrates the cellulose blank structure 2 with formed cellulose products 1 cut out from the cellulose blank structure 2, according to an alternative embodiment.

In the embodiment shown in FIG. 8 a, the dry-forming mould system S comprises a plurality of collecting units 5, where each collecting unit 5 comprises an elongated product flow channel 5a for receiving and guiding the formed cellulose products 1. The product flow channel 5a is arranged and designed for receiving several consecutive cellulose products 1 from the forming mould 3, and may have the configuration described in the embodiments above. The collecting unit 5 may further comprise a curing device 5b arranged in connection to the product flow channel 5a, as described above.

The dry-forming mould system S further comprises a plurality of release units 6, as shown in FIG. 8a. Each release unit 6 is arranged for releasing the cellulose products 1 into a corresponding product flow channel 5a of the collecting unit 5, where the release unit 6 pushes consecutive cellulose products 1 into the product flow channel 5a for stacking the cellulose products 1 in the product flow channel 5a. The dry-forming mould system S may further comprises cutting units 7 for, at least partly, cutting out the cellulose products 1 from the cellulose blank structure 2 into a desired shape in the forming mould 3 or in connection to the forming mould 3. One cutting unit 7 is suitably arranged as an integrated part of each forming mould 3, and may have the configurations described in the embodiments above.

Instead of using two or more collecting units 5 arranged side-by-side as shown in FIG. 8a, the collecting unit 5 may in other non-illustrated embodiments have a different design with a wider product flow channel 5a for receiving and guiding two or more parallel flows of consecutive cellulose products 1 from the one or more forming moulds 3. The two or more parallel flows of cellulose products 1 may suitable be arranged side-by-side in the wider product flow channel 5a, and in this way two or more stacks of cellulose products 1 are formed in the collecting unit 5. The collecting unit 5 with this configuration may further comprise a curing device 5b arranged in connection to the product flow channel 5a, in the same way as described above, for simultaneous treatment of the two or more parallel flows of cellulose products 1.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims. Reference signs mentioned in the claims should not be seen as limiting the extent of the matter protected by the claims, and their sole function is to make claims easier to understand.

### REFERENCE SIGNS

1: Cellulose product
1a: Outer product edge
2: Cellulose blank structure
2a: Residual portion
2b: Compacted section
2c: Connection portion
3: Forming mould
3a: First mould part
3b: Second mould part
4: Transporting unit
5: Collecting unit
5a: Product flow channel
5b: Curing device
5c: Heating unit
5d: Escape opening
5e: Dehumidifier
6: Release unit
7: Cutting device
7a: Cutting edge
7b: Compression section
7c: Indentation section
7d: Outer edge
D: Depth
D_{P}: Pressing direction
L: Cutting line
O_{I}: Inlet opening
O_{O}: Outlet opening
O_{P}: Pressing operation
P_{F}: Forming pressure
S: Dry-forming mould system
T_{CD}: Curing dwell time
T_{F}: Forming temperature

1-35. (canceled)

36. A dry-forming mould system comprising a forming mould for dry-forming cellulose products from an air-formed cellulose blank structure, wherein the forming mould comprises a first mould part and a second mould part configured for interacting with each other during dry-forming of the cellulose products from the air-formed cellulose blank structure in the forming mould,
wherein the dry-forming mould system comprises a transporting unit and a collecting unit, wherein the transporting unit is configured for transporting the dry-formed cellulose products from the forming mould to the collecting unit, wherein the collecting unit comprises an elongated product flow channel configured for receiving and guiding the cellulose products, wherein the product flow channel is configured for receiving several consecutive cellulose products from the forming mould.

37. The dry-forming mould system according to claim 36,
wherein the product flow channel comprises an inlet opening and an outlet opening, wherein the product flow channel has an extension between the inlet opening and the outlet opening, wherein the product flow channel is configured for guiding the cellulose products from the inlet opening to the outlet opening.

38. The dry-forming mould system according to claim 36,
wherein the product flow channel has a cross-sectional shape corresponding to an outer peripheral shape of the cellulose products.

39. The dry-forming mould system according to claim 36,
wherein the dry-forming mould system further comprises a release unit configured for releasing the cellulose products into the product flow channel.

40. The dry-forming mould system according to claim 39,
wherein the release unit pushes consecutive cellulose products into the product flow channel for stacking the cellulose products in the product flow channel.

41. The dry-forming mould system according to claim 36,
wherein the collecting unit comprises a curing device arranged in connection to the product flow channel, wherein the curing device comprises a heating unit configured for heating the cellulose products in the product flow channel, wherein the heating unit is configured to heat the cellulose products to a predetermined temperature that creates evaporation of water from the cellulose products and to cure additives in the cellulose products.

42. The dry-forming mould system according to claim 41,
wherein the heating unit is configured for blowing a stream of hot air into the product flow channel.

43. The dry-forming mould system according to claim 42,
wherein the curing device comprises a dehumidifier wherein the dehumidifier is configured for dehumidifying the stream of hot air blown into the product flow channel.

44. The dry-forming mould system according to claim 36,
wherein the product flow channel comprises at least one escape opening configured for allowing evaporated water to escape from the product flow channel.

45. The dry-forming mould system according to claim 36,
wherein the product flow channel is configured for guiding the cellulose products during a predetermined curing dwell time.

46. The dry-forming mould system according to claim 36,
wherein the dry-forming mould system further comprises a storing unit, wherein the storing unit is configured for receiving a plurality of stacked cellulose products from the product flow channel.

47. A method for collecting cellulose products in a dry-forming mould system comprising a forming mould for dry-forming the cellulose products from an air-formed cellulose blank structure, wherein the forming mould comprises a first mould part and a second mould part configured for interacting with each other during dry-forming of the cellulose products from the air-formed cellulose blank structure in the forming mould, wherein the dry-forming mould system comprises a transporting unit and a collecting unit having an elongated product flow channel,
wherein the method comprises the steps of:
transporting the dry-formed cellulose products by means of the transporting unit from the forming mould to the collecting unit; and
receiving several consecutive cellulose products from the forming mould in the product flow channel and guiding the cellulose products in the product flow channel.

48. The method according to claim 47,
wherein the collecting unit comprises a curing device arranged in connection to the product flow channel, wherein the curing device comprises a heating unit, wherein the method further comprises the step: heating the cellulose products by means of the heating unit in the product flow channel to a predetermined temperature creating evaporation of water from the cellulose products and curing of additives in the cellulose products.

49. The method according to claim 48,
wherein the method further comprises the step: blowing a stream of hot air by means of the heating unit into the product flow channel.

50. The method according to claim 49,
wherein the curing device comprises a dehumidifier, wherein the method further comprises the step: dehumidifying the stream of hot air blown into the product flow channel by means of the dehumidifier.
